(19) United States
(12) Patent Application Publication
(10) Pub. No.: US 2013/0261969 A1
(43) Pub. Date: Oct. 3, 2013

(54) NAVIGATION APPARATUS, CONTROL METHOD, PROGRAM, AND STORAGE MEDIUM

(71) Applicants: Yukihito Nakamura, Kounosu-shi (JP); Chihiro Hirose, Kawagoe (JP)

(72) Inventors: Yukihito Nakamura, Kounosu-shi (JP); Chihiro Hirose, Kawagoe (JP)

(73) Assignee: Pioneer Corporation, Kanagawa (JP)

(21) Appl. No.: 13/993,563

(22) PCT Filed: Dec. 24, 2010
(86) PCT No.: PCT/JP2010/073326

§ 371 Date: Jun. 12, 2013

(51) Int. Cl. G01C 21/36

(52) U.S. Cl. CPC G01C 21/3644
USPC 701/533

(57) ABSTRACT

A navigation apparatus includes an obtaining unit, a storage unit, an extracting unit, a navigation unit and a determination unit. The obtaining unit obtains an image captured by an imaging unit. The storage unit stores landmark information relating to facilities. The extracting unit extracts at least one landmark corresponding to a navigation point from the stored landmark information when moving along a route. The navigation unit guides the navigation point by use of the at least one landmark extracted. The determination unit determines, at a position possible to take an image of a characteristic object corresponding to the landmark information thereat, whether the characteristic object can be recognized from the obtained image. The navigation unit guides the navigation point after omitting a landmark corresponding to the characteristic object from the at least one extracted landmark if the determination unit determines that the characteristic object cannot be recognized.

### TECHNICAL FIELD

The present invention relates to a guiding technology by use of an image obtained from an imaging unit mounted on a moving body.

### BACKGROUND TECHNIQUE

Conventionally, there is known a technique for displaying the indication of the guidance over the image captured by a camera mounted on the moving body. For example, Patent Reference-1 discloses a technique for extracting an object served as a mark from the image showing the intersection and its vicinity thereby to generate and output the guidance information corresponding to the object served as a mark. Patent Reference-2 discloses a technique for executing the pattern matching between an image captured from the camera and a registered template thereby to identify the range corresponding to the template in the image.
Patent Reference-1: Japanese Patent Application Laid-open under No. 2009-186372
Patent Reference-2: Japanese Patent Application Laid-open under No. 2003-203219

### DISCLOSURE OF INVENTION

### Problem to be Solved by the Invention

Because information relating to landmarks stored in advance is not updated on a real-time basis, there are cases that the landmark has already vanished away or the store in the building has been replaced. In these cases, the navigation by use of the information relating to the landmark possibly makes the user get confused. In case of searching an object that can be a mark from the entire image according to Patent Reference-1, there is a problem that the huge processing load is needed.

The above is an example of the problem to be solved by the present invention. An object of the present invention is to provide a navigation apparatus capable of properly guiding the way without letting the user get confused.

### Means for Solving the Problem

One invention is a navigation apparatus comprising: an obtaining unit configured to obtain an image captured by an imaging unit; a storage unit for storing landmark information relating to facilities; an extracting unit configured to extract at least one landmark corresponding to a navigation point from the landmark information stored by the storage unit when a moving body moves along a route; a navigation unit configured to guide the navigation point by use of the at least one landmark extracted; and a determination unit configured to determine, at a position possible to take an image of a characteristic object corresponding to the landmark information thereat, whether or not the characteristic object can be recognized from the image obtained by the obtaining unit, the navigation unit being configured to guide the navigation point after omitting a landmark corresponding to the characteristic object from the at least one landmark extracted by the extracting unit if the determination unit determines that the characteristic object cannot be recognized.

Another invention is a control method executed by a navigation apparatus including a storage unit for storing landmark information relating to facilities, comprising: an obtaining process which obtains an image captured by an imaging unit; an extracting process which extracts at least one landmark corresponding to a navigation point from the landmark information stored by the storage unit when a moving body moves along a route; a navigation process which guides the navigation point by use of the at least one landmark extracted; and a determination process which determines, at a position possible to take an image of a characteristic object corresponding to the landmark information thereat, whether or not the characteristic object can be recognized from the image obtained through the obtaining process, wherein the navigation process guides the navigation point after omitting a landmark corresponding to the characteristic object from the at least one landmark extracted through the extracting process if the determination process determines that the characteristic object cannot be recognized.

Another invention is a program executed by a navigation apparatus including a storage unit for storing landmark information relating to facilities, making the navigation apparatus function as: an obtaining unit configured to obtain an image captured by an imaging unit; an extracting unit configured to extract at least one landmark corresponding to a navigation point from the landmark information stored by the storage unit when a moving body moves along a route; a navigation unit configured to guide the navigation point by use of the at least one landmark extracted; and a determination unit configured to determine, at a position possible to take an image of a characteristic object corresponding to the landmark information thereat, whether or not the characteristic object can be recognized from the image obtained by the obtaining unit, the navigation unit being configured to guide the navigation point after omitting a landmark corresponding to the characteristic object from the at least one landmark extracted by the extracting unit if the determination unit determines that the characteristic object cannot be recognized.

### BRIEF DESCRIPTION OF THE DRAWINGS

FIG. 1 is an example of a schematic configuration of the navigation apparatus according to the embodiment.

FIG. 2A is an example of the captured image showing the intersection Pi and its vicinity. FIG. 2B indicates an overview of the process in which the landmark information is obtained.

FIGS. 3A and 3B each is an example of the captured image showing the landmark.

FIGS. 4A and 4B schematically show the determination method of the search range.

FIG. 5 is an example of a flowchart showing a procedure of the landmark detection process.

FIG. 6A is an example of the target image for processing according to the first navigation example. FIG. 6B is an example of a flowchart showing a procedure of the process according to the first navigation example.

FIG. 7A is an example of the target image for processing according to the second navigation example. FIG. 7B is an example of a flowchart showing a procedure of the process according to the second navigation example.

FIG. 8 is an example of a flowchart indicating a procedure of the process according to the third navigation example.

FIGS. 9A to 9C are examples of the images showing the object for controlling traffic.

FIG. 10 is an example of a flowchart indicating a procedure of the process according to the fourth navigation example.

FIG. 11A shows an overview of the fifth navigation example.

FIG. 11B is an example of a flowchart indicating a procedure of the process according to the fifth navigation example.

### DETAILED DESCRIPTION OF THE PREFERRED EMBODIMENTS

According to one aspect of the present invention, there is provided a navigation apparatus comprising: an obtaining unit configured to obtain an image captured by an imaging unit; a storage unit for storing landmark information relating to facilities; an extracting unit configured to extract at least one landmark corresponding to a navigation point from the landmark information stored by the storage unit when a moving body moves along a route; a navigation unit configured to guide the navigation point by use of the at least one landmark extracted; and a determination unit configured to determine, at a position possible to take an image of a characteristic object corresponding to the landmark information thereat, whether or not the characteristic object can be recognized from the image obtained by the obtaining unit, the navigation unit being configured to guide the navigation point after omitting a landmark corresponding to the characteristic object from the at least one landmark extracted by the extracting unit if the determination unit determines that the characteristic object cannot be recognized.

The above navigation apparatus includes an obtaining unit, a storage unit, an extracting unit, a navigation unit and a determination unit. The obtaining unit obtains an image captured by an imaging unit. The storage unit stores landmark information relating to facilities. The extracting unit extracts at least one landmark corresponding to a navigation point from the landmark information stored by the storage unit when a moving body moves along a route. The navigation unit guides the navigation point by use of the at least one landmark extracted. The determination unit determines, at a position possible to take an image of a characteristic object corresponding to the landmark information thereat, whether or not the characteristic object can be recognized from the image obtained by the obtaining unit. The navigation unit guides the navigation point after omitting a landmark corresponding to the characteristic object from the at least one landmark extracted by the extracting unit if the determination unit determines that the characteristic object cannot be recognized.

According to the above-mentioned embodiment, on the basis of the captured image, the navigation apparatus determines whether or not the characteristic object corresponding to the stored landmark information actually exists, and executes the guidance based on the landmark information only when it determines that the characteristic object exists. Thereby, even when the facility corresponding to the landmark information has already vanished away at the time of the guidance, the navigation apparatus can execute the guidance based on other information without letting the user get confused.

In one mode of the navigation apparatus, the determination unit determines whether or not any other characteristic object corresponding to another landmark which the extracting unit does not extract can be recognized if the determination unit determines that the characteristic object cannot be recognized, and the navigation unit guides the navigation point by using the other landmark if the determination unit determines that the other characteristic object can be recognized. Thereby, even when the facility corresponding to the landmark information has already vanished away at the time of the guidance, the navigation apparatus can execute the guidance without letting the user get confused.

In another mode of the navigation apparatus, the determination unit determines whether or not an alternative characteristic object for navigating can be extracted from the image if the characteristic object cannot be recognized, and the navigation unit guides the navigation point by using information of the alternative characteristic object if the determination unit extracted the alternative characteristic object. Thereby, even when the facility corresponding to the landmark information has already vanished away at the time of the guidance, the navigation apparatus can execute the guidance without letting the user get confused.

In another mode of the navigation apparatus, the alternative characteristic object is an object for controlling traffic provided at the navigation point. In this mode, by using the object for controlling traffic instead of the landmark information, the navigation apparatus can execute the guidance at various kinds of navigation points.

In another mode of the navigation apparatus, the storage unit stores information related to the navigation point, and the navigation unit guides the navigation point based on the information related to the navigation point other than the landmark information if the determination unit determines that the characteristic object cannot be recognized. The term “information related to the navigation point” herein includes the name of the navigation point and information relating to districts corresponding to each road branching off at the navigation point, for example. In this mode, even when the navigation apparatus was not able to detect the characteristic object, the navigation apparatus can execute the guidance without letting the user get confused.

In another mode of the navigation apparatus, the navigation unit guides the navigation point based on information indicating which direction to go at the navigation point if the determination unit determines that the characteristic object cannot be recognized. In this mode, even when the navigation apparatus was not able to detect the characteristic object, the navigation apparatus can execute the guidance without letting the user get confused.

In another mode of the navigation apparatus, the navigation unit informs that the at least one landmark extracted by the extracting unit cannot be recognized if the determination unit determines that the characteristic object cannot be recognized. In this mode, the navigation apparatus can explicitly inform the user of the fact that the landmark has vanished away.

According to another aspect of the present invention, there is provided a control method executed by a navigation apparatus including a storage unit for storing landmark information relating to facilities, comprising: an obtaining process which obtains an image captured by an imaging unit; an extracting process which extracts at least one landmark corresponding to a navigation point from the landmark information stored by the storage unit when a moving body moves along a route; a navigation process which guides the navigation point by use of the at least one landmark extracted; and a determination process which determines, at a position possible to take an image of a characteristic object corresponding to the landmark information thereat, whether or not the characteristic object can be recognized from the image obtained through the obtaining process, wherein the navigation process guides the navigation point after omitting a landmark corresponding to the characteristic object from the at least one landmark extracted through the extracting process if the determination process determines that the characteristic object cannot be recognized. By executing the above-mentioned control method, even when the facility corresponding to the landmark information has already vanished away at the time of the guidance, the navigation apparatus can execute the guidance based on other information without letting the user get confused.

According to still another aspect of the present invention, there is provided a program executed by a navigation apparatus including a storage unit for storing landmark information relating to facilities, making the navigation apparatus function as: an obtaining unit configured to obtain an image captured by an imaging unit; an extracting unit configured to extract at least one landmark corresponding to a navigation point from the landmark information stored by the storage unit when a moving body moves along a route; a navigation unit configured to guide the navigation point by use of the at least one landmark extracted; and a determination unit configured to determine, at a position possible to take an image of a characteristic object corresponding to the landmark information thereat, whether or not the characteristic object can be recognized from the image obtained by the obtaining unit, the navigation unit being configured to guide the navigation point after omitting a landmark corresponding to the characteristic object from the at least one landmark extracted by the extracting unit if the determination unit determines that the characteristic object cannot be recognized. By the above program being installed and executed, even when the facility corresponding to the landmark information has already vanished away at the time of the guidance, the navigation apparatus can execute the guidance based on other information without letting the user get confused. Ina preferred example, the above program is stored in a recording medium.

### Embodiment

Now, a preferred embodiment of the present invention will be described below with reference to the attached drawings. Hereinafter, the term “destination” herein indicates a destination which the user sets to the navigation apparatus 1, and “transit point” herein indicates a point which the user sets to the navigation apparatus 1 as a point for stopping off on the way to the destination. The term “destination equivalent” indicates the destination and the transit point if they are not distinguished from each other. The term “landmark” herein indicates a sign of a facility recognized as a mark in case of route guidance. The term “navigation point” indicates a target location of the guidance in case of the route guidance.

[Schematic Configuration]

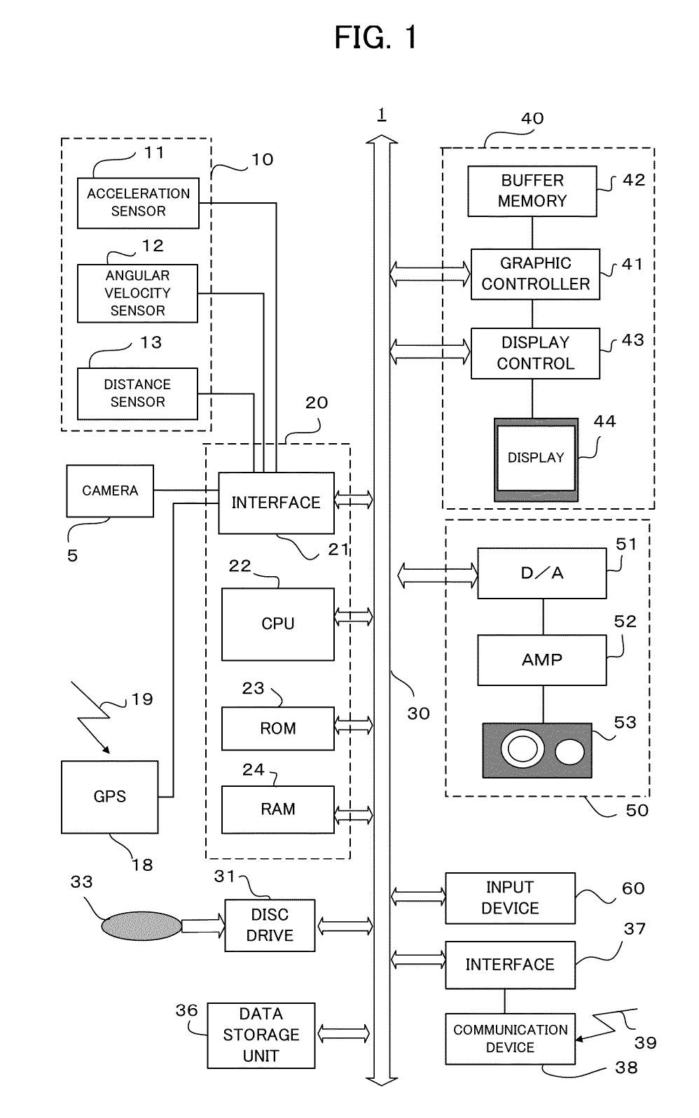

FIG. 1 shows a configuration of a navigation apparatus 1. The navigation apparatus is mounted on a vehicle and connected to the camera 5. As shown in FIG. 1, the navigation apparatus 1 includes a stand-alone position measurement device 10, a GPS receiver 18, a system controller 20, a disc drive 31, a data storage unit 36, a communication interface 37, a communication device 38, a display unit 40, a sound output unit 50, and an input device 60.

The stand-alone position measurement device 10 includes an acceleration sensor 11, an angular velocity sensor 12 and a distance sensor 13. The acceleration sensor 11 includes a piezoelectric element, for example, and detects the acceleration degree of the vehicle and outputs the acceleration data. The angular velocity sensor 12 includes a vibration gyroscope, for example, and detects the angular velocity of the vehicle at the time of changing the direction of the vehicle and outputs the angular velocity data and the relative direction data. The distance sensor 13 measures vehicle speed pulses including a pulse signal generated with the wheel rotation of the vehicle.

The GPS receiver 18 receives an electric wave 19 for transmitting downlink data including position measurement data from plural GPS satellites. The position measurement data is used for detecting the absolute position (hereinafter referred to as “present location”) of the vehicle from longitude and latitude information.

The system controller 20 includes an interface 21, a CPU (Central Processing Unit) 22, a ROM (Read Only Memory) 23 and a RAM (Random Access Memory) 24, and controls the entire navigation apparatus 1.

The interface 21 executes the interface operation with the acceleration sensor 11, the angular velocity sensor 12, the distance sensor 13 and the GPS receiver 18. Then, the interface 21 inputs the vehicle speed pulse, the acceleration data, the relative direction data, the angular velocity data, the GPS measurement data and the absolute direction data into the system controller 20. The CPU 22 controls the entire system controller 20 by executing a program prepared in advance. The ROM 23 includes a non-volatile memory (not shown) in which a control program for controlling the system controller 20 is stored. The RAM 24 readably stores various kinds of data such as route data preset by the user via the input device 60, and supplies a working area to the CPU 22.

The system controller 20, the disc drive 31 such as a CD-ROM drive or a DVD-ROM drive, the data storage unit 36, the communication interface 37, the display unit 40, the sound output unit 50 and the input device 60 are connected to each other via a bus line 30.

Under the control of the system controller 20, the disc drive 31 reads contents data such as sound data and video data from a disc 33 such as a CD and a DVD to output the contents data. The disc drive 31 may be the CD-ROM drive or the DVD-ROM drive, or may be a drive compatible between the CD and the DVD.

The data storage unit 36 includes HDD, for example, and stores various kinds of data used for a navigation process such as map data. The data storage unit 36 is an example of “storage unit” according to the present invention. The map data includes a database (referred to as “landmark information DB”) in which information (referred to as “landmark information IL”) on each landmark is associated with information on a navigation point corresponding to the landmark. In particular, the landmark information IL indicates information relating to a landmark such as an image of the landmark, a facility name shown by the landmark and a location of the landmark.

The communication device 38 includes an FM tuner, a beacon receiver, a mobile phone and a dedicated communication card, for example, and obtains information (hereinafter referred to as “VICS information”) delivered from a VICS (Vehicle Information Communication System) center by the electric wave 39. The communication interface 37 executes the interface operation of the communication device 38 to input the VICS information into the system controller 20.

The display unit 40 displays various kinds of display data on a display device such as a display under the control of the system controller 20. In particular, the system controller 20 reads the map data from the data storage unit 36. The display unit 40 displays the map data read from the data storage unit 36 by the system controller 20 on its display screen. The display unit 40 includes a graphic controller 41 for controlling the entire display unit 40 on the basis of the control data transmitted from the CPU 22 via the bus line 30, a buffer memory 42 having a memory such as a VRAM (Video RAM) for temporarily storing immediately displayable image information, a display control unit 43 for controlling a display 44 such as a liquid crystal and a CRT (Cathode Ray Tube) on the basis of the image data outputted from the graphic controller 41, and the display 44. The display 44 is formed by a liquid crystal display device of the opposite angle 5-10 inches, and is mounted at or near a front panel of the vehicle.

The sound output unit 50 includes a D/A (Digital to Analog) converter 51 for executing D/A conversion of the sound digital data transmitted from the CD-ROM drive 31, a DVD-ROM 32 or the RAM 24 via the bus line 30 under the control of the system controller 20, an amplifier (AMP) 52 for amplifying a sound analog signal outputted from the D/A converter 51, and a speaker 53 for converting the amplified sound analog signal into the sound and outputting it to the vehicle compartment.

The input device 60 includes keys, switches, buttons, a remote controller and a sound input device, which are used for inputting various kinds of commands and data. The input device 60 is arranged at or near the display 44 and a front panel of a main body of an on-vehicle electric system loaded on the vehicle. In addition, in such a case that the display 44 is in a touch panel system, a touch panel provided on the display screen of the display 44 functions as the input device 60, too.

The camera 5 has a predetermined angle of view, and generates an image (referred to as “captured image”) on the basis of the light which the imaging sensor receives. The camera 5 is directed to the forward direction of the vehicle. The camera 5 is an example of “imaging unit” according to the present invention.

It is noted that the system controller 20 functions as “the obtaining unit”, “the extracting unit”, “the navigation unit” and “the determination unit” according to the present invention.

[Control Method]

Next, a description will be given of the route guidance method executed by the system controller 20. In summary, when the vehicle comes close to a navigation point during the route guidance, the system controller 20 determines whether or not the landmark indicated by the landmark information IL associated with the navigation point is actually shown in the captured image. Then, the system controller 20 guides the way by use of the landmark if the landmark is shown, whereas the system controller 20 guides the way on the basis of the information other than the landmark if the landmark is not shown.

<Landmark Detection Process>

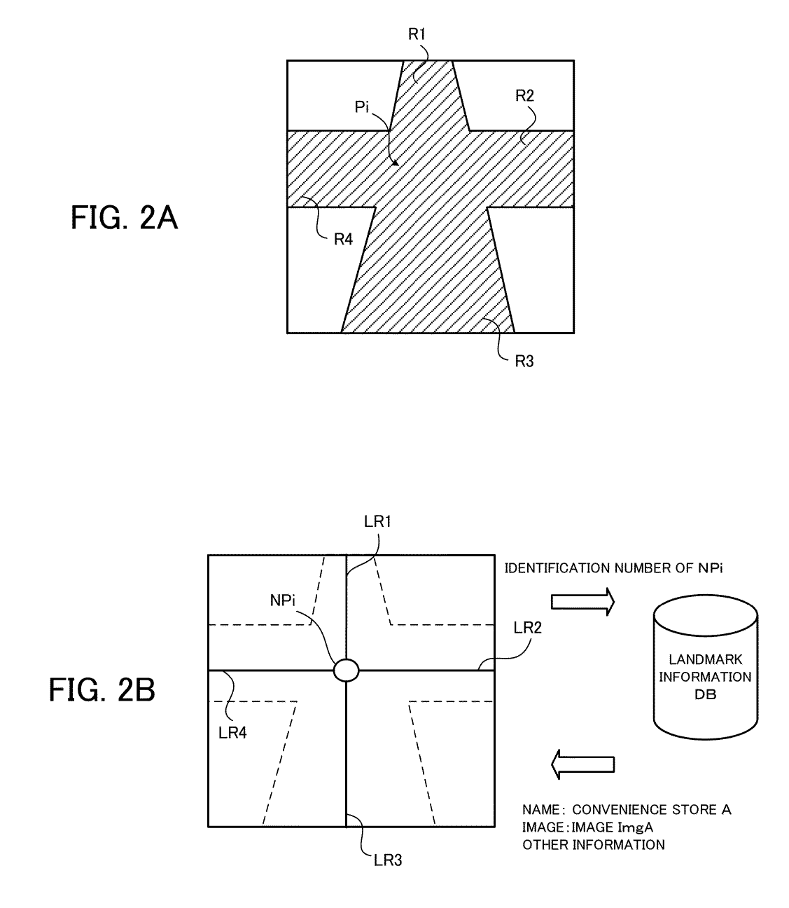

First, a description will be given of a process (referred to as “landmark detection process”) for detecting a landmark indicated by the landmark information IL from the captured image. When coming close to a navigation point within a predetermined distance, the system controller 20 reads out the landmark information IL from the landmark information DB. The description thereof will be given with reference to FIGS. 2A and 2B.

FIG. 2A is an example of the captured image generated at the time of getting close to an intersection “Pi” which is a navigation point within the predetermined distance. FIG. 2B shows an overview of the process for reading out the landmark information IL from the landmark information DB. FIG. 2B expresses the captured image shown in FIG. 2A by using a node “NPi” indicating the intersection Pi, the links “LR1” to “LR4” indicating the roads “R1” to “R4” connected to the intersection Pi in accordance with the expression of the map data. For the sake of explanation, facilities existing near the intersection Pi are not shown in FIGS. 2A and 2B.

The system controller 20 recognizes its present location based on detection signals outputted from the GPS receiver 18 and/or the stand-alone position measurement device 10. Thereafter, with reference to the map data, the system controller 20 recognizes the intersection Pi that is a navigation point based on the present location. Then, with reference to the landmark information DB, the system controller 20 obtains the landmark information IL associated with the intersection Pi on the basis of an identification number of the node NPi indicating the intersection Pi. In FIG. 2B, the system controller 20 obtains the name “convenience store A” indicating a facility associated with the intersection Pi, the image “ImgA” that is a logo of the facility “convenience store A” and other information as the landmark information IL. The expression “A” herein indicates predetermined character string. Then, the system controller 20 stores the landmark information IL on a primary memory such as the RAM 24.

Next, by image recognition through pattern matching processing, the system controller 20 determines whether or not the landmark indicated by the landmark information IL is shown in the captured image in which the intersection Pi is shown. Hereinafter, a target captured image of the pattern matching processing is referred to as “target image Itag”.

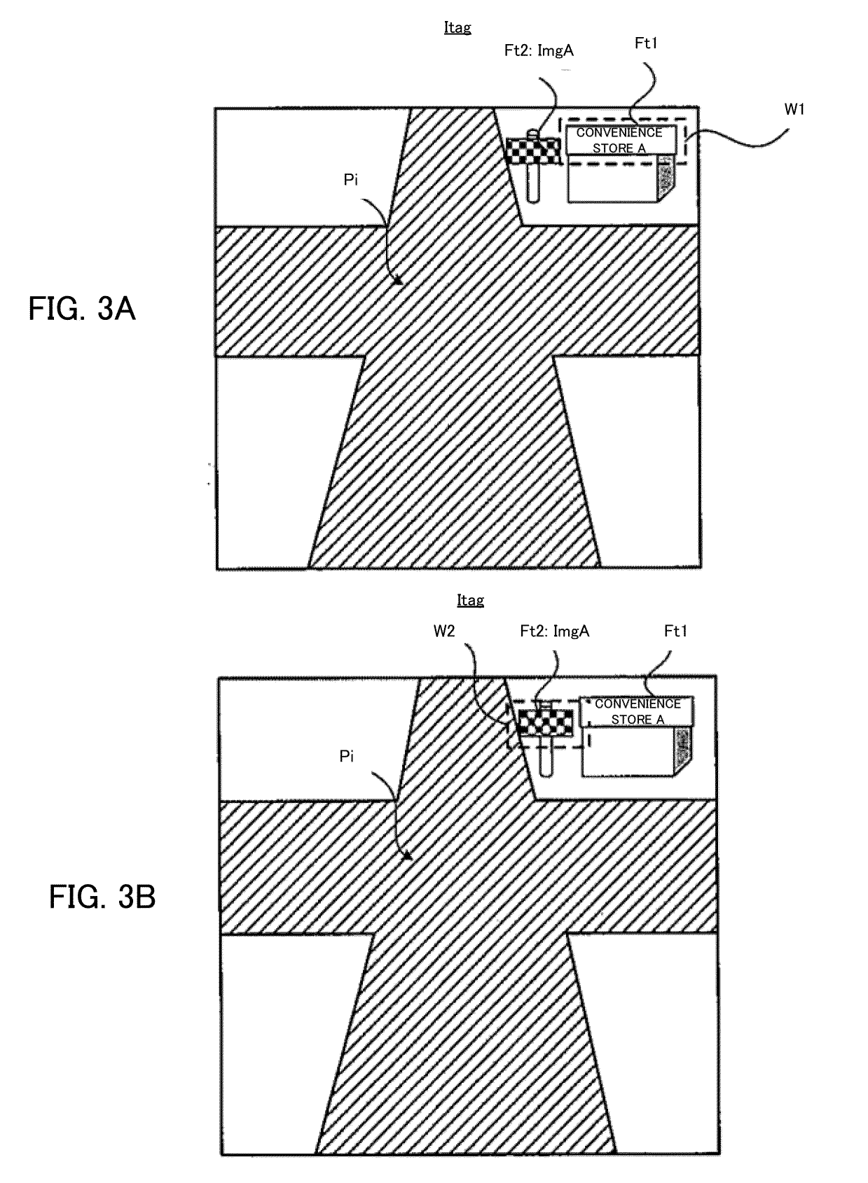

The concrete description thereof will be given with reference to FIGS. 3A and 3B. FIGS. 3A and 3B each is an example of the target image Itag showing the intersection Pi that is a navigation point. In the target image Itag in FIGS. 3A and 3B, there are shown the characteristic object “Ft1” which is a signboard having the facility name “convenience store A” thereon and the characteristic object “Ft2” indicating the image ImgA that is a logo of the facility “convenience store A”.

First, the system controller 20 regards the image indicating the facility name “convenience store A” identified by the landmark information IL and the image ImgA as templates, and compares each of the templates to a predetermined range of the target image Itag shown in FIGS. 3A and 3B. In other words, the system controller 20 determines a target range (referred to as “search range”) in the target image Itag to be compared to each of the templates, and calculates the degree of similarities between each of the templates and the search range. The determination method of the search range will be described later.

If the degree of the similarity is equal to or larger than a predetermined value, the system controller 20 determines that the landmark indicated by the template is shown in the target image Itag. For example, the predetermined value mentioned above is set through experimental trials in advance to the lower limit of the degree of the similarity with which it can be considered that the characteristic object in the captured image coincides with the landmark information IL. On the other hand, if the degree of the similarity is smaller than the predetermined value, the system controller 20 changes the search range and calculates the degree of similarities between the search range after the change and the template.

In particular, if the system controller 20 regards the name “convenience store A” as a template, the system controller 20 determines that the degree of the similarity is equal to or larger than the predetermined value at the time of comparing the template to the search range “W1” as shown in FIG. 3A. If the system controller 20 regards the image ImgA as a template, the system controller 20 determines that the degree of the similarity is equal to or larger than the predetermined value at the time of comparing the template to the search range “W2” as shown in FIG. 3B.

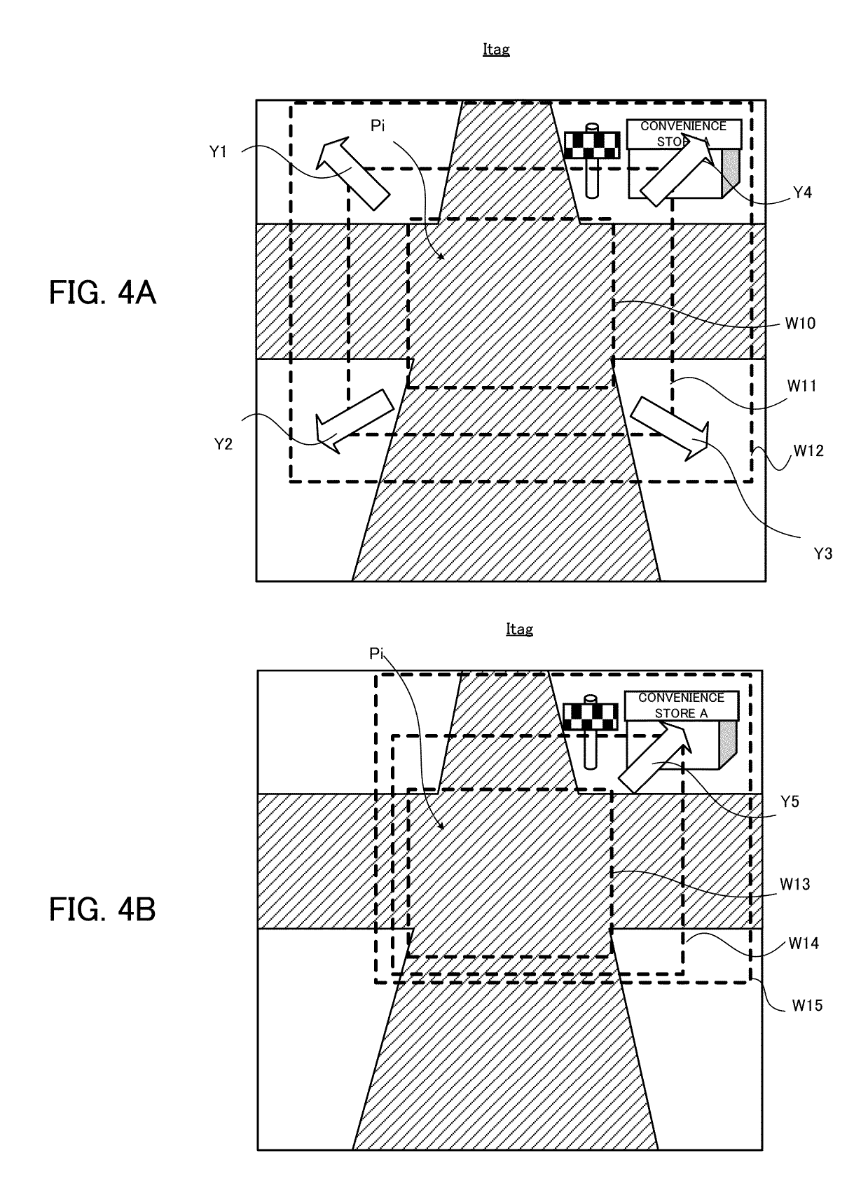

A description will be given of the determination method of the search range in the captured image with reference to FIGS. 4A and 4B through two concrete examples that are a first example and a second example.

FIG. 4A schematically shows the determination method of the search range according to the first example. The ranges “W10” to “W12” in FIG. 4A chronologically indicate ranges (referred to as “searched range”) consisting of search ranges where the search has already been done.

As shown in FIG. 4A, according to the first example, the system controller 20 enlarges the searched range evenly in the longitudinal and the lateral directions indicated by arrows “Y1” to “Y4”, the center of the searched range coinciding with the intersection Pi. Namely, on the basis of a presumption that the landmark generally exists near the intersection, the system controller 20 preferentially selects positions closer to the center of the intersection Pi as the search range. Thereby, the system controller 20 can promptly detect the characteristic object coinciding with the landmark information IL from the captured image.

FIG. 4B schematically shows the determination method of the search range according to the second example. The ranges “W13” to “W15” in FIG. 4B chronologically indicate the searched ranges. As shown in FIG. 4B, according to the second example, the system controller 20 mainly enlarges the searched range in the direction where the landmark exists as indicated by the arrow “Y5”. In this way, if the system controller 20 can recognize the position of the landmark based on the landmark information IL, the system controller 20 enlarges the searched range from the position of the intersection Pi toward the position of the landmark. Thereby, the system controller 20 can promptly detect the characteristic object coinciding with the landmark indicated by the landmark information IL from the captured image.

When the system controller 20 detects the characteristic object coinciding with the landmark indicated by the landmark information IL from the captured image as a result of the above-mentioned processing, the system controller 20 guides the user concerning the navigation point by using the landmark information IL. In the example shown in FIGS. 3A and 3B, after the detection of the characteristic objects Ft1 and Ft2 coinciding with the landmarks indicated by the landmark information IL at the intersection Pi, the system controller 20 outputs the audio guidance indicating turning right or left at the intersection Pi with reference to the landmark “convenience store A” as a mark while highlighting either or both of the characteristic objects Ft1, Ft2 in the captured image by edging them.

In this way, during the route guidance, after making sure that there actually exists the landmark indicated by the landmark information IL stored in the data storage unit 36, the system controller 20 guides the way by use of the landmark information IL. Thereby, the system controller 20 prevents the user from getting confused by the guidance with any landmark no longer existing.

(Process Flow)

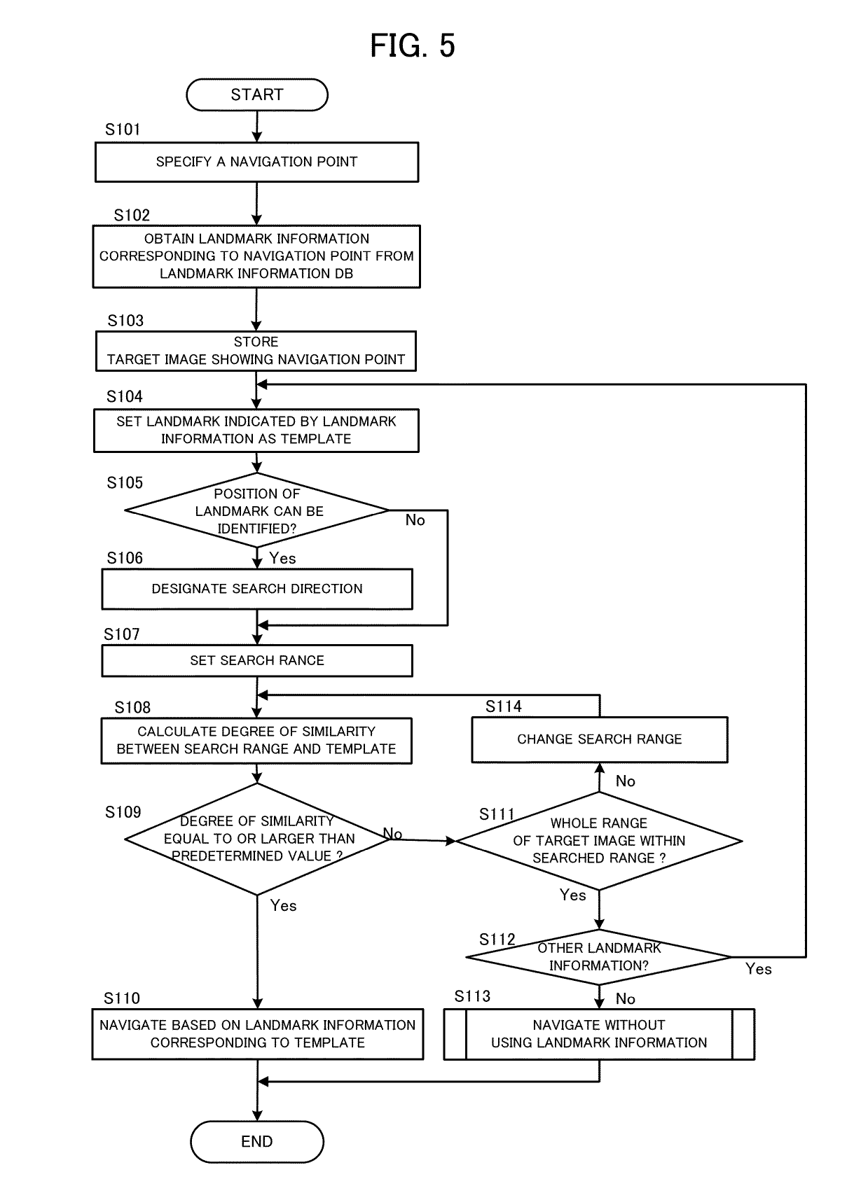

FIG. 5 is an example of a flowchart showing a procedure of the landmark detection process. For example, the system controller 20 executes the process indicated by FIG. 5 when the system controller 20 determines that the vehicle comes close to a navigation point within a predetermined distance during the route guidance.

First, the system controller 20 specifies the navigation point (step S101). In particular, with reference to the map data, and on the basis of the present location and the route to the destination equivalent, the system controller 20 identifies the next navigation point that the vehicle is going to pass. Then, the system controller 20 obtains the landmark information IL corresponding to the navigation point from the landmark information DB (step S102). At that time, the system controller 20 stores the landmark information IL on the primary memory.

Then, the system controller 20 stores the target image Itag showing the navigation point on the memory such as the data storage unit 36 (step S103). Next, the system controller 20 sets a landmark indicated by one piece of the landmark information IL as a template (step S104).

Next, the system controller 20 determines whether or not the position of the landmark can be identified (step S105). When the system controller 20 determines that the position of the landmark can be identified (step S105; Yes), the system controller 20 designates the search direction (step S106). In particular, the system controller 20 sets the search direction to the direction from the navigation point toward the position of the facility corresponding to the landmark. On the other hand, when the system controller 20 determines that it is impossible to identify the position of the landmark (step S105; No), the system controller 20 does not designate the search direction. Thereafter, the system controller 20 sets the search range based on the position of the navigation point (step S107). At that time, for example, the system controller 20 may determine the position of the navigation point in the target image Itag in advance, or may identify the position of the navigation point in the target image Itag based on the distance between the present location and the navigation point with reference to a map or an equation prepared in advance. The above-mentioned map or equation is prepared in advance through experimental trials, for example.

Next, the system controller 20 calculates the degree of similarity between the search range and the template (step S108). When the degree of the similarity is equal to or larger than a predetermined value (step S109; Yes), the system controller 20 guides the user based on the landmark information IL corresponding to the template (step S110). In this way, by guiding the user by using the landmark information IL corresponding to the landmark actually shown in the captured image, the system controller 20 can prevent the user from getting confused even when the facility corresponding to the landmark information IL no longer exists.

When the degree of the similarity is smaller than the predetermined value (step S109; No), the system controller 20 determines whether or not the entire area of the target image Itag is within the searched range (step S111). When the entire area of the target image Itag is within the searched range (step S111; Yes), the system controller 20 determines whether or not there is another piece of landmark information IL (step S112). In contrast, when the system controller 20 determines that the entire area of the target image Itag is not within the searched range yet (step S111; No), the system controller 20 changes the search range (step S114), and executes the process at and after step S108 again.

When the system controller 20 determines that there is another piece of landmark information IL (step S112; Yes), the system controller 20 sets the landmark indicated by the other piece of landmark information IL as the template (step S104), and executes the process at and after step S105. In contrast, when the system controller 20 determines that any other piece of landmark information IL does not exist (step S112; No), the system controller 20 guides the way without using the landmark information IL (step S113). A description of the process at step S113 in detail will be given in the below section.

<Case of No Landmark>

Next, a description will be given of a guiding method in a case where the characteristic object corresponding to the landmark information IL cannot be recognized in the captured image as a result of the above-mentioned landmark detection process. Hereinafter, a description will be given of a first to a five navigation examples which are concrete examples of the guiding method without using the landmark information IL. These navigation examples may be executed in combination.

### First Navigation Example

According to the first navigation example, the system controller 20 detects another characteristic object (hereinafter referred to as “other characteristic object Fex”) from the target image Itag, the other characteristic object Fex corresponding to a landmark other than the landmark indicated by the landmark information IL. Then, the system controller 20 guides the way by use of the other characteristic object Fex if the system controller 20 can detect the other characteristic object Fex.

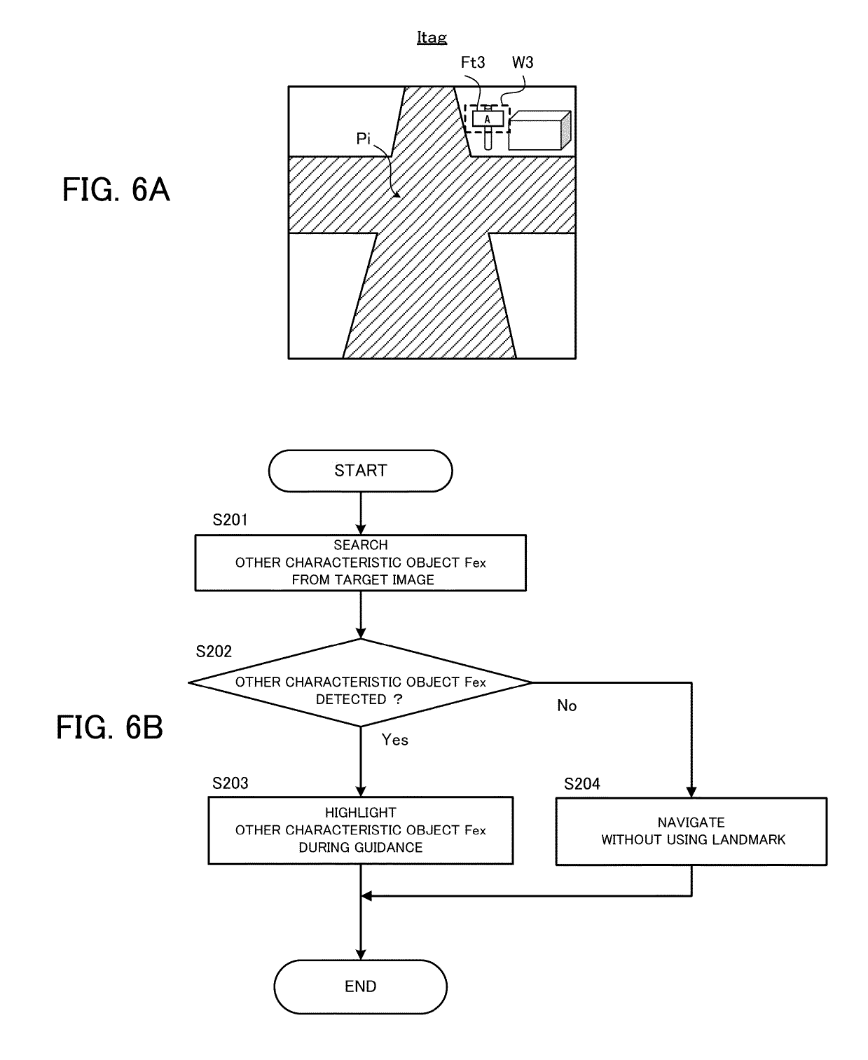

FIG. 6A is an example of the target image Itag in a case where there exists the characteristic object “Ft3” near the intersection Pi that is a navigation point, the characteristic object Ft3 indicating the signboard of the convenience store A which is not registered in the landmark information DB as the landmark information IL. As shown in FIG. 6A, through the detection of the character string in the search range determined again based on the position of the intersection Pi, the system controller 20 detects the existence of the characteristic object Ft3 including the character string in the search range “W3”.

In this case, the system controller 20 highlights the characteristic object Ft3 from the displayed captured image and outputs the audio guidance indicating turning right or left with reference to the characteristic object Ft3 as a mark. For example, during the route guide, the system controller 20 displays the dashed frame of the search range W3 over the captured image and blinks it, and outputs the audio guidance such as “Turn right xx meter ahead. The blinking position is the landmark.”.

FIG. 6B is an example of a flowchart showing a procedure of the process according to the first navigation example. The system controller 20 executes the process of the flowchart in FIG. 6B in case of proceeding with the process at step S113 in FIG. 5.

First, the system controller 20 searches the other characteristic object Fex from the target image Itag (step S201). In particular, the system controller 20 searches a signboard and other characteristic objects which can be a landmark from the target image Itag.

Then, when the system controller 20 determines that the other characteristic object Fex has been detected (step S202; Yes), the system controller 20 highlights the other characteristic object Fex during the guidance of the navigation point (step S203). For example, when the system controller 20 displays the captured image on the display unit 40, the system controller 20 blinks the edge of the other characteristic object Fex. Preferably, through audio guidance, the system controller 20 informs that the highlighted portion is a landmark.

When the system controller 20 determines that the other characteristic object Fex cannot be detected from the target image Itag (step S202; No), the system controller 20 guides the user without using the landmark (step S204). In particular, in this case, the system controller 20 executes the fourth navigation example and/or the fifth navigation example described later.

In this way, according to the first navigation example, even when the system controller 20 does not use the landmark information IL, the system controller 20 can let the user clearly identify the navigation point by using another landmark.

### Second Navigation Example

According to the second navigation example, in addition to the first navigation example, the system controller 20 refers to a database (referred to as “characteristic object DB”) in which each image indicating the characteristic object such as a signboard of a facility is associated with information relating to the characteristic object such as the facility name indicated by the characteristic object, and guides the way by using the information in the characteristic object DB when the detected other characteristic object Fex coincides with an image registered in the characteristic object DB.

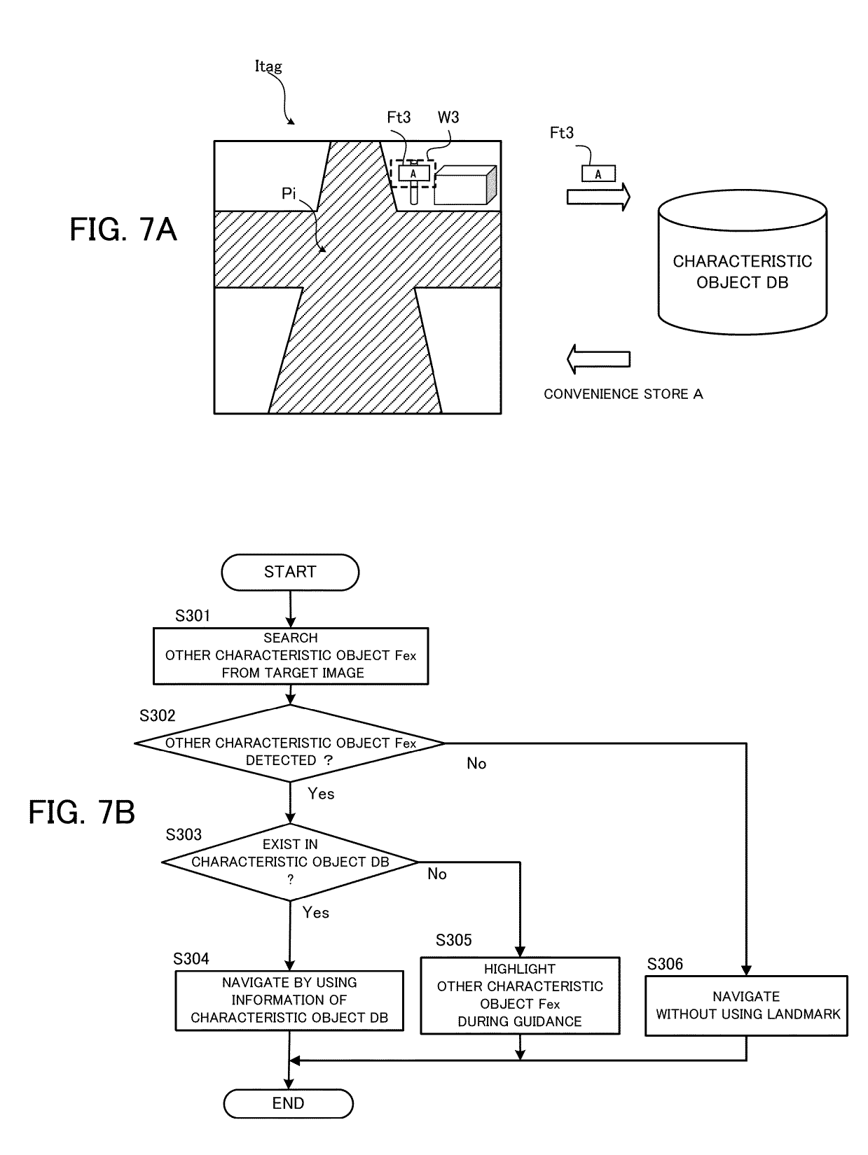

FIG. 7A schematically shows the process according to the second navigation example. The system controller 20 detects the characteristic object Ft3 from the target image Itag in the same way as the case shown in FIG. 6A, and the system controller 20 determines whether or not the characteristic object Ft3 coincides with each image registered in the characteristic object DB. For example, substantially in the same way as the method of comparing the search range to each template mentioned in the explanation of the landmark detecting method, when degree of the similarity between the image of the characteristic object Ft3 and an image registered in the characteristic object DB is equal to or larger than a predetermined value, the system controller 20 determines that these two coincide with each other.

After determining that there exists the image in the characteristic object DB coinciding with the image of the characteristic object Ft3, the system controller 20 obtains the facility name “convenience store A” from the characteristic object DB, the facility name corresponding to the characteristic object Ft3 associated with the matched image. Then, the system controller 20 guides the user by using information obtained from the characteristic object DB. For example, in the same way as the first navigation example, the system controller 20 highlights the characteristic object Ft3 in the captured image and outputs the audio guide such as “Turn right xx meter ahead. The convenience store “A” is the landmark.”.

FIG. 7B is an example of a flowchart indicating a procedure of the process according to the second navigation example. The flowchart indicated by FIG. 7B shows the procedure of the process in which the first navigation example and the second navigation example are combined. The system controller 20 executes the process of the flowchart shown in FIG. 7B in case of proceeding with the process at step S113 in FIG. 5.

First, the system controller 20 searches the other characteristic object Fex from the target image Itag (step S301). When the system controller 20 determines that the other characteristic object Fex has been detected (step S302; Yes), the system controller 20 determines whether or not the image of the other characteristic object Fex exists in the characteristic object DB (step S303). When the system controller 20 determines that the image of the other characteristic object Fex exists in the characteristic object DB (step S303; Yes), the system controller 20 guides the user by using information of the landmark information DB (step S304). For example, the system controller 20 highlights the other characteristic object Fex in the captured image and outputs the audio guidance by using the facility name corresponding to the other characteristic object Fex obtained from the characteristic object DB.

When the system controller 20 determines that the image of the characteristic object does not exist in the characteristic object DB (step S303; No), the system controller 20 highlights the other characteristic object Fex during the route guidance in the same way as the first navigation example (step S305).

When the system controller 20 determines that the other characteristic object Fex cannot be detected from the target image Itag (step S302; No), the system controller 20 guides the user without using the landmark (step S306). In particular, in this case, the system controller 20 executes the fourth navigation example and/or the fifth navigation example mentioned later.

In this way, by using the characteristic object DB, the system controller 20 can let the user identify the navigation point based on more information compared to the first navigation example.

### Third Navigation Example

According to the third navigation example, in addition to the first navigation example and/or the second navigation example, the system controller 20 guides the way by using a character or character string indicated by the other characteristic object Fex. For example, according to the examples shown in FIGS. 6A and 7A, the system controller 20 recognizes the character string “A” displayed in the image of the characteristic object Ft3, and outputs the audio guidance such as “Turn right xx meter ahead. “A” is the landmark.”.

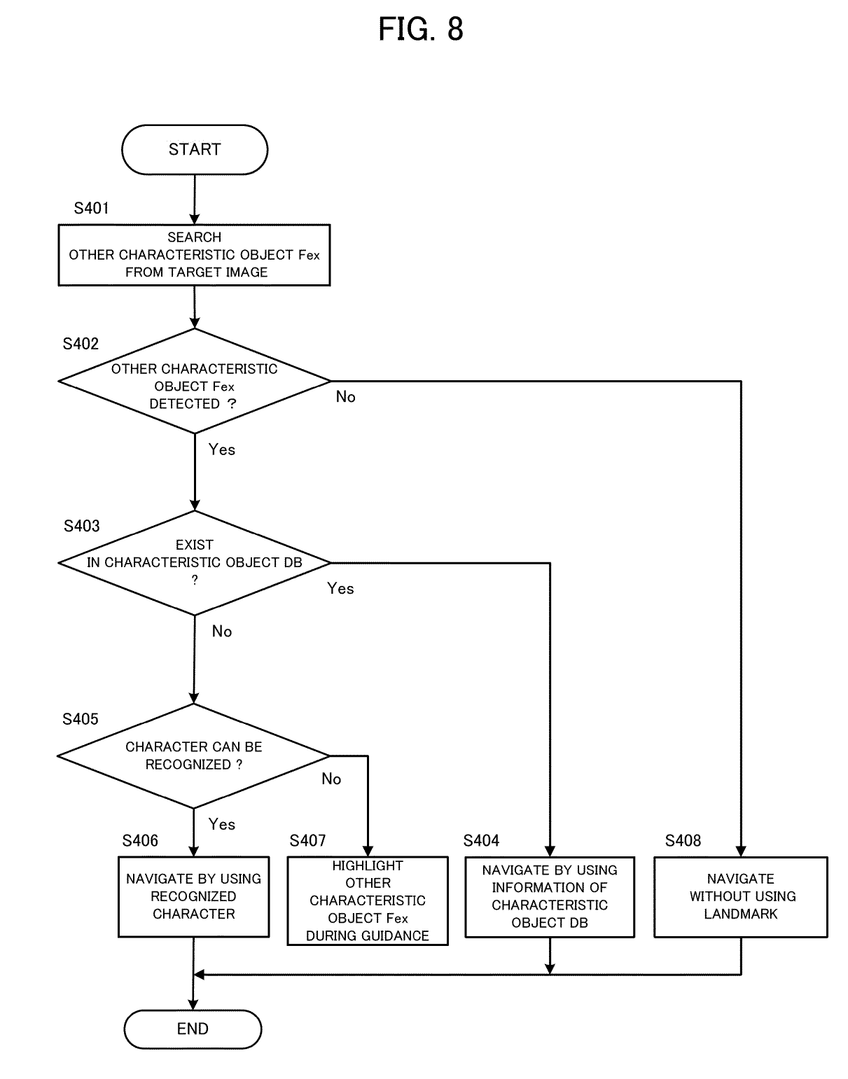

FIG. 8 is an example of a flowchart indicating a procedure of the process according to the third navigation example. The flowchart indicated by FIG. 8 shows the procedure of the process in which the first to the third navigation examples are combined. The system controller 20 executes the process of the flowchart in FIG. 8 in case of proceeding with the process at step S113 in FIG. 5.

First, the system controller 20 searches the other characteristic object Fex from the target image Itag (step S401). When the system controller 20 determined that the other characteristic object Fex has been detected (step S402; Yes), the system controller 20 determines whether or not the image of the other characteristic object Fex exists in the characteristic object DB (step S403). When the system controller 20 determined that the image of the other characteristic object Fex exists in the characteristic object DB (step S403; Yes), the system controller 20 guides the way by using the information of the characteristic object DB (step S404).

When the system controller 20 determined that the image of the other characteristic object Fex does not exist in the characteristic object DB (step S403; No), the system controller 20 determines whether or not it can recognize any character(s) indicated by other characteristic object Fex (step S405). When the system controller 20 determines that it can recognize any character(s) indicated by the other characteristic object Fex (step S405; Yes), the system controller 20 guides the way by using the recognized character(s) (step S406). For example, the system controller 20 highlights the other characteristic object Fex in the captured image and outputs the audio guidance by using the recognized character(s).

When the system controller 20 determines that it cannot recognize any character(s) indicated by the other characteristic object Fex (step S405; No), the system controller 20 highlights the characteristic object during the guidance of the navigation point in the same way as the first navigation example (step S407).

When the system controller 20 determines that the other characteristic object Fex cannot be detected from the target image Itag (step S402; No), the system controller 20 guides the way without using the landmark (step S408). In particular, in this case, the system controller 20 executes the fourth navigation example and/or the fifth navigation example mentioned later.

In this way, by recognizing the character(s) indicated by the other characteristic object Fex, the system controller 20 can let the user identify the navigation point based on more information compared to the first navigation example even when the detected other characteristic object Fex does not exist in the characteristic object DB.

### Fourth Navigation Example

According to the fourth navigation example, in addition to or instead of the first to the third navigation examples, the system controller 20 detects an object (referred to as “object for controlling traffic”) for controlling traffic such as a traffic signal, a signboard indicating the intersection name, a direction signboard (a traffic sign) thereby to guide the way by use of the object for controlling traffic, the object for controlling traffic generally existing at an intersection.

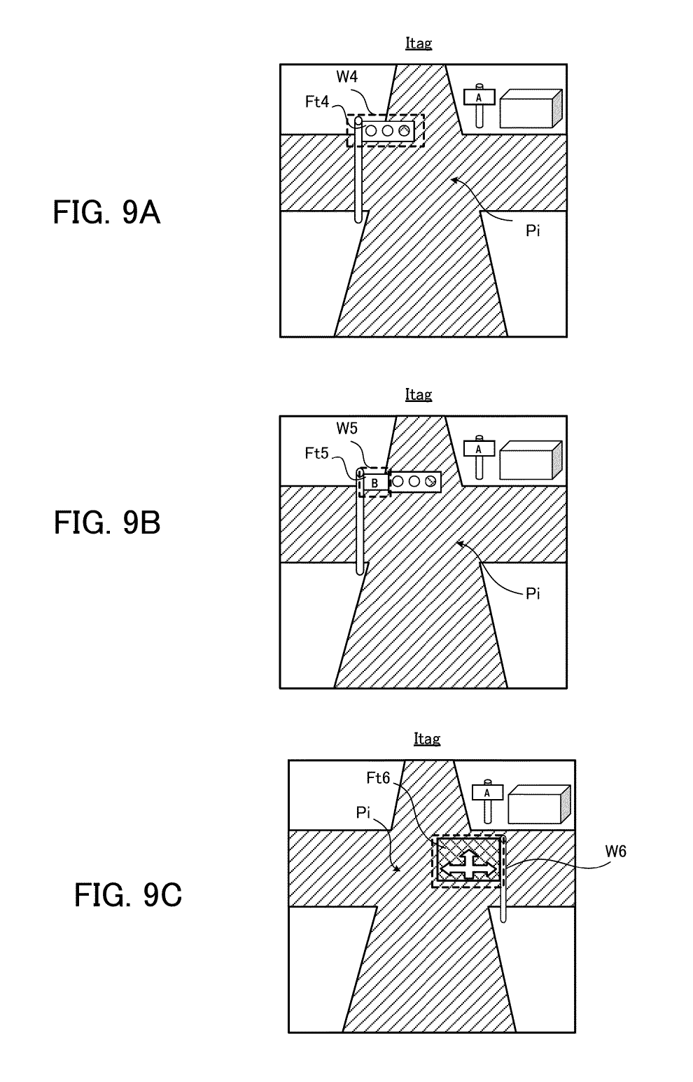

FIG. 9A is an example of the target image Itag showing the characteristic object “Ft4” that is a traffic sign.

First, in the same way as the landmark detection process, the system controller 20 designates a predetermined search range to calculate the degree of a similarity between a template representing a traffic signal and the search range. The above-mentioned template representing the traffic signal is stored in a memory such as the data storage unit 36 in advance.

Thereafter, through the comparison between the search range “W4” and the template representing the traffic signal, the system controller 20 determines that the similarity is equal to or larger than a predetermined value. Then, in this case, for example, the system controller 20 outputs the audio guidance such as “Turn right xx meter ahead. The traffic signal is the landmark” while highlighting the characteristic object Ft4.

Preferably, in addition to the above-mentioned process, the system controller 20 additionally detects the state of the traffic signal out of red, green or yellow to output the audio guidance by use of the state of the traffic signal. For example, in case of detecting the red state of the traffic signal, the system controller 20 outputs the audio guidance such as “Turn right xx meter ahead. The red signal is the landmark.”.

FIG. 9B is an example of the target image Itag showing the characteristic object “Ft5” corresponding to a sign indicating the intersection name “B” (“B” is character string). In this case, through the comparison between the search range “W5” and a template representing the sign indicating the intersection name, the system controller 20 determines that the similarity is equal to or larger than a predetermined value. Then, for example, the system controller 20 outputs the audio guidance “Turn right xx meter ahead. “B” is the landmark” or “xx meter ahead, turn right at “B”” while highlighting the characteristic object Ft5.

FIG. 9C is an example of the target image Itag showing the characteristic object “Ft6” corresponding to a direction signboard. In this case, through the comparison between the search range “W6” and a template representing the direction signboard, the system controller 20 determines that the similarity is equal to or larger than a predetermined value. Then, the system controller 20 outputs the audio guidance such as “Turn right xx meter ahead. The direction signboard (traffic sign) is the landmark” while highlighting the characteristic object Ft5.

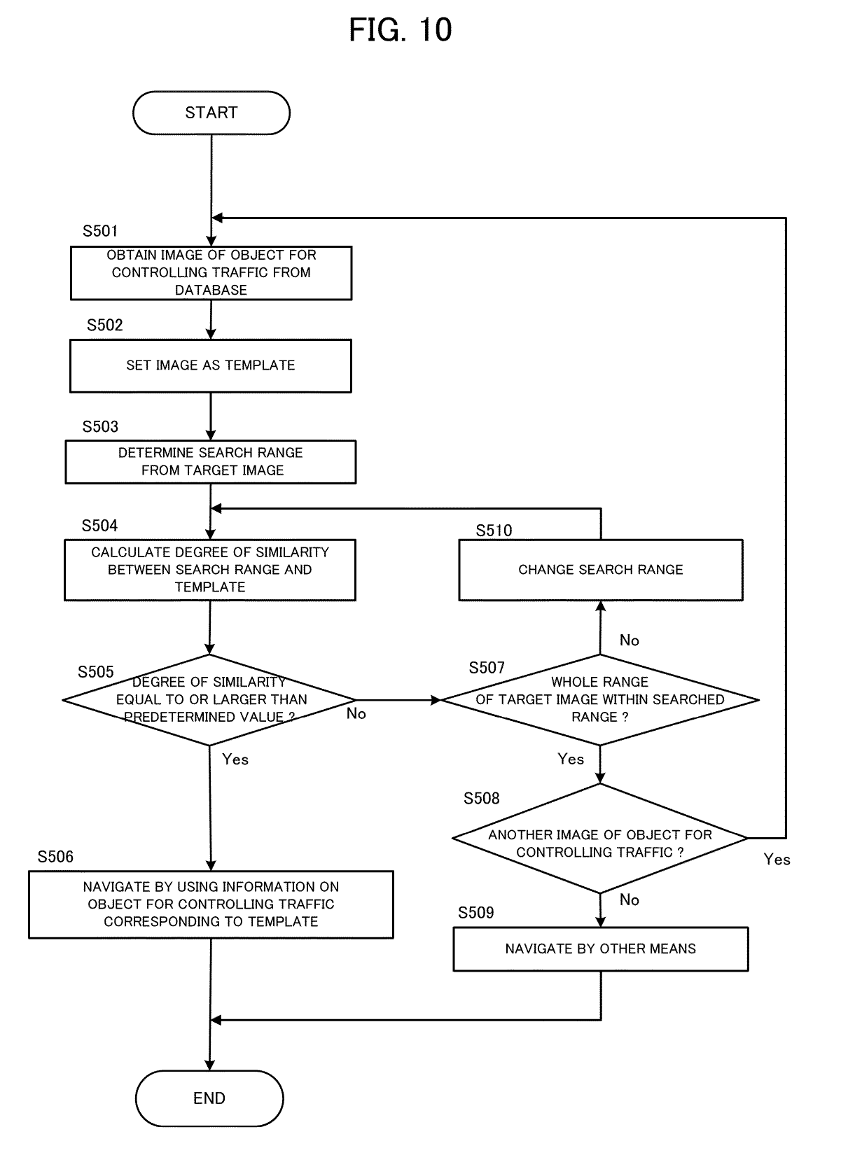

FIG. 10 is an example of a flowchart showing a procedure of the process according to the fourth navigation example. The system controller 20 executes the process of the flowchart in FIG. 10 at the time of proceeding with the process at step S113, step S204, step S306, or step S408.

First, the system controller 20 obtains one of images of objects for controlling traffic from a database storing the images of the objects for controlling traffic (step S501). Then, the system controller 20 sets the image of the object for controlling traffic as a template (step S502).

Next, the system controller 20 determines the search range from the target image Itag based on the position of the navigation point (step S503). Then, the system controller 20 calculates the similarity between the search range and the template (step S504). When the similarity is equal to or larger than a predetermined value (step S505; Yes), the system controller 20 guides the way based on information on the object for controlling traffic corresponding to the template (step S506). For example, the system controller 20 outputs the audio guidance by using the name of the object for controlling traffic while highlighting the search range.

In contrast, when the similarity is smaller than the predetermined value (step S505; No), the system controller 20 determines whether or not the entire area of the target image Itag is within the searched range (step S507). When the entire area of the target image Itag is within the searched range (step S507; Yes), the system controller 20 determines whether or not another image of the object for controlling traffic exists in the database (step S508). When the system controller 20 determines that the entire area of the target image Itag is not within the searched range (step S507; No), the system controller 20 changes the search range (step S510), and executes the process at and after step S504 again.

When the system controller 20 determines that another image of the object for controlling traffic exists in the database (step S508; Yes), the process goes back to step S501. In contrast, when the system controller 20 determines that any other image of the object for controlling traffic does not exist in the database (step S508; No), the system controller 20 guides the way based on another method (step S509). In particular, in this case, the system controller 20 guides the way based on the fifth navigation example.

In this way, by navigating based on the object for controlling traffic, the system controller 20 can let the user identify any kind of the navigation point.

### Fifth Navigation Example

According to the fifth navigation example, in addition to or instead of the first to the fourth navigation examples, after the identification of the intersection that is a navigation point, the system controller 20 guides the way based on information (simply referred to as “relevant information”) related to the intersection on the map data.

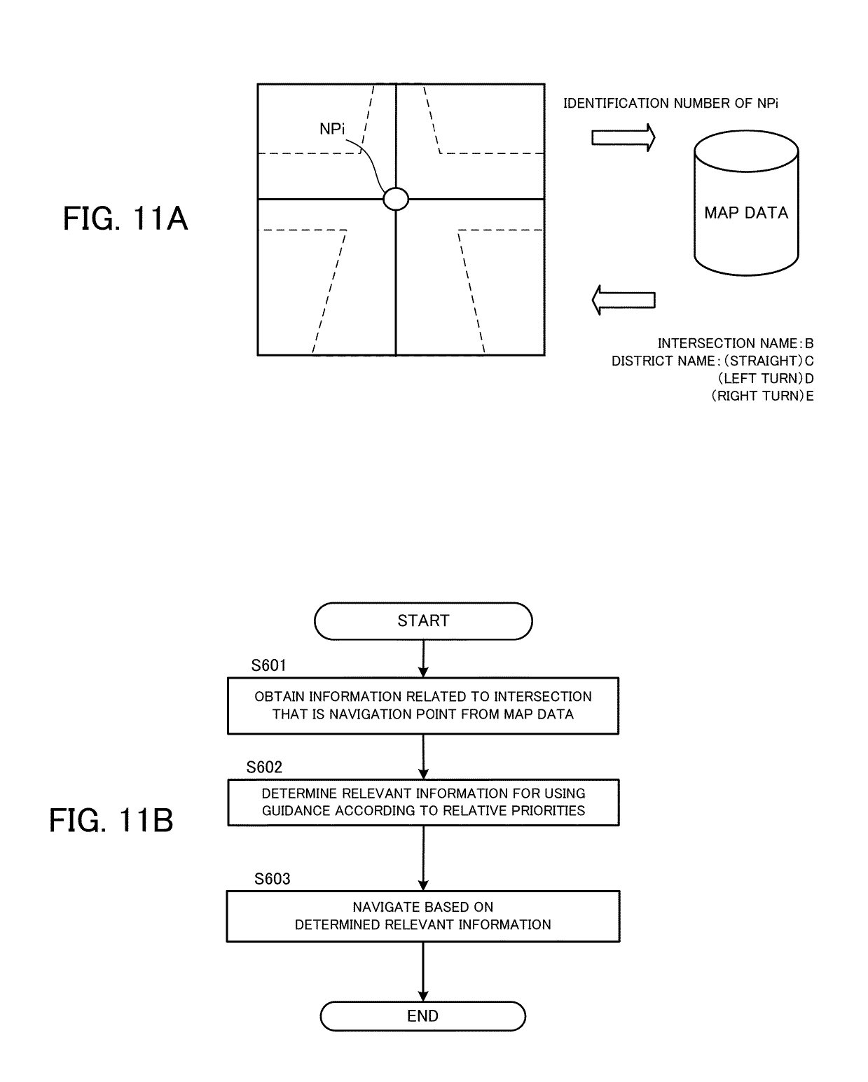

FIG. 11A shows an overview of the fifth navigation example. As shown in FIG. 11A, after the identification of the intersection Pi, on the basis of the identification number of the node NPi corresponding to the intersection Pi, the system controller 20 extracts the relevant information of the intersection Pi from the map data. In FIG. 11A, the system controller 20 obtains the name “B” of the intersection Pi from the map data and also obtains the district names “C”, “D” and “E”, e.g. Shibuya, existing ahead of roads branching off from the intersection Pi. Here, each of the expression “B” to “E” is a character or character string.

Then, when showing the direction to go at the intersection Pi, the system controller 20 uses the intersection name “B” and/or the district name “C”, “D” or “E” each obtained from the map data. In particular, on the basis of the degree of the relative priority predetermined according to each type of the relevant information in advance, the system controller 20 decides which to use out of the intersection name “B” and the district names “C” to “E”. Then, in case of using the intersection name “B”, the system controller 20 outputs the audio guidance such as “Turn right at “B” xx meter ahead.”. In contrast, in case of using the district names “C” to “E”, the system controller 20 outputs the audio guidance such as “xx meter ahead, turn right toward “E””.

FIG. 11B is an example of a flowchart showing a procedure of the process according to the fifth navigation example. The system controller 20 executes the process indicated by the flowchart in FIG. 11B when proceeding with the process at step S113, step S204, step S306, step S408 or step S509.

First, the system controller 20 obtains the relevant information of the intersection Pi from the map data (step S601). Next, on the basis of the degree of the priority, the system controller 20 determines which piece of relevant information to use for the route guidance out of the obtained relevant information (step S602). Then, the system controller 20 guides the way based on the determined relevant information (step S603).

### Other Navigation Examples

In addition to or instead of the above-mentioned navigation examples, the system controller 20 may guide the way by using the information indicating which direction to go at the navigation point without using information for identifying the navigation point such as a landmark. For example, in this case, the system controller 20 outputs the audio guidance such as “Turn right xx meter ahead”. In addition to or instead of the above-mentioned example, the system controller 20 may display an arrow indicating the direction to go over the captured image. Thus, in this case, the system controller 20 guides the way without particularly using any kind of information for identifying the navigation point such as a landmark.

In addition to the above-mentioned navigation examples, by audio output or on the display, the system controller 20 may inform that any characteristic object corresponding to the landmark indicated by the landmark information IL was not able to be detected in the captured image. For example, in this case, the system controller 20 outputs the audio guidance such as “The convenience store “A” serving as a landmark was not able to be detected.”. Thereby, the system controller 20 can inform the user of the fact that the landmark which had ever been existed no longer exists.

[Modification]

According to the first navigation example, the system controller 20 designates an image of the landmark indicated by the landmark information IL as a template to calculate the degree of each similarity between the search range and the template and to determine whether or not the similarity is equal to or larger than the predetermined value. Instead of this, if the landmark information IL indicates a character or character string, the system controller 20 reads out a character or character string from the search range thereby to determine whether or not these characters or character string coincide with each other. In the second navigation example, the system controller 20 also determines whether or not in the search range there exists a character or character string coinciding with a predetermined character or character string registered in the characteristic object DB instead of comparing the image corresponding to the template to the image corresponding to the search range.

### INDUSTRIAL APPLICABILITY

Preferably, this invention can be applied to a navigation apparatus mounted on a vehicle, a PND (Personal Navigation Device), and other apparatus guiding the way by using an image captured by a camera.

### BRIEF DESCRIPTION OF REFERENCE NUMBERS

1 Navigation apparatus
10 Stand-alone position measurement device
12 GPS receiver
20 System controller
22 CPU
36 Data storage unit
38 Communication device
40 Display unit
44 Display

1. A navigation apparatus comprising:
an obtaining unit configured to obtain an image captured by an imaging unit;
a storage unit for storing landmark information relating to facilities;
an extracting unit configured to extract at least one landmark corresponding to a navigation point from the landmark information stored by the storage unit when a moving body moves along a route;
a navigation unit configured to guide the navigation point by use of the at least one landmark extracted; and
a determination unit configured to determine, at a position possible to take an image of a characteristic object corresponding to the landmark information thereat, whether or not the characteristic object can be recognized from the image obtained by the obtaining unit,
wherein the navigation unit guides the navigation point after omitting a landmark corresponding to the characteristic object from the at least one landmark extracted by the extracting unit if the determination unit determines that the characteristic object cannot be recognized.

2. The navigation apparatus according to claim 1,
wherein the determination unit determines whether or not any other characteristic object corresponding to another landmark which the extracting unit does not extract can be recognized if the determination unit determines that the characteristic object cannot be recognized,
and wherein the navigation unit guides the navigation point by using the other landmark if the determination unit determines that the other characteristic object can be recognized.

3. The navigation apparatus according to claim 1,
wherein the determination unit determines whether or not an alternative characteristic object for navigating can be extracted from the image if the characteristic object cannot be recognized, and
wherein the navigation unit guides the navigation point by using information of the alternative characteristic object if the determination unit extracted the alternative characteristic object.

4. The navigation apparatus according to claim 3,
wherein the alternative characteristic object is an object for controlling traffic provided at the navigation point.

5. The navigation apparatus according to claim 1,
wherein the storage unit stores information related to the navigation point, and
wherein the navigation unit guides the navigation point based on the information related to the navigation point other than the landmark information if the determination unit determines that the characteristic object cannot be recognized.

6. The navigation apparatus according to claim 1,
wherein the navigation unit guides the navigation point based on information indicating which direction to go at the navigation point if the determination unit determines that the characteristic object cannot be recognized.

7. The navigation apparatus according to claim 1,
wherein the navigation unit informs that the at least one landmark extracted by the extracting unit cannot be recognized if the determination unit determines that the characteristic object cannot be recognized.

8. A control method executed by a navigation apparatus including a storage unit for storing landmark information relating to facilities, comprising:
an obtaining process which obtains an image captured by an imaging unit;
an extracting process which extracts at least one landmark corresponding to a navigation point from the landmark information stored by the storage unit when a moving body moves along a route;
a navigation process which guides the navigation point by use of the at least one landmark extracted; and
a determination process which determines, at a position possible to take an image of a characteristic object corresponding to the landmark information thereat, whether or not the characteristic object can be recognized from the image obtained through the obtaining process,
wherein the navigation process guides the navigation point after omitting a landmark corresponding to the characteristic object from the at least one landmark extracted through the extracting process if the determination process determines that the characteristic object cannot be recognized.

9. A program stored on a non-transitory storage medium and executed by a navigation apparatus including a storage unit for storing landmark information relating to facilities, making the navigation apparatus function as:
an obtaining unit configured to obtain an image captured by an imaging unit;
an extracting unit configured to extract at least one landmark corresponding to a navigation point from the landmark information stored by the storage unit when a moving body moves along a route;
a navigation unit configured to guide the navigation point by use of the at least one landmark extracted; and
a determination unit configured to determine, at a position possible to take an image of a characteristic object corresponding to the landmark information thereat, whether or not the characteristic object can be recognized from the image obtained by the obtaining unit,
the navigation unit being configured to guide the navigation point after omitting a landmark corresponding to the characteristic object from the at least one landmark extracted by the extracting unit if the determination unit determines that the characteristic object cannot be recognized.

10. (canceled)

11. The navigation apparatus according to claim 2,
wherein the determination unit determines whether or not an alternative characteristic object for navigating can be extracted from the image if the characteristic object cannot be recognized, and
wherein the navigation unit guides the navigation point by using information of the alternative characteristic object if the determination unit extracted the alternative characteristic object.

12. The navigation apparatus according to claim 2,
wherein the storage unit stores information related to the navigation point, and
wherein the navigation unit guides the navigation point based on the information related to the navigation point other than the landmark information if the determination unit determines that the characteristic object cannot be recognized.

13. The navigation apparatus according to claim 3,
wherein the storage unit stores information related to the navigation point, and
wherein the navigation unit guides the navigation point based on the information related to the navigation point other than the landmark information if the determination unit determines that the characteristic object cannot be recognized.

14. The navigation apparatus according to claim 4,
wherein the storage unit stores information related to the navigation point, and
wherein the navigation unit guides the navigation point based on the information related to the navigation point other than the landmark information if the determination unit determines that the characteristic object cannot be recognized.

15. The navigation apparatus according to claim 2,
wherein the navigation unit guides the navigation point based on information indicating which direction to go at the navigation point if the determination unit determines that the characteristic object cannot be recognized.

16. The navigation apparatus according to claim 3,
wherein the navigation unit guides the navigation point based on information indicating which direction to go at the navigation point if the determination unit determines that the characteristic object cannot be recognized.

17. The navigation apparatus according to claim 4,
wherein the navigation unit guides the navigation point based on information indicating which direction to go at the navigation point if the determination unit determines that the characteristic object cannot be recognized.

18. The navigation apparatus according to claim 5,
wherein the navigation unit guides the navigation point based on information indicating which direction to go at the navigation point if the determination unit determines that the characteristic object cannot be recognized.

19. The navigation apparatus according to claim 2,
wherein the navigation unit informs that the at least one landmark extracted by the extracting unit cannot be recognized if the determination unit determines that the characteristic object cannot be recognized.

20. The navigation apparatus according to claim 3,
wherein the navigation unit informs that the at least one landmark extracted by the extracting unit cannot be recognized if the determination unit determines that the characteristic object cannot be recognized.

21. The navigation apparatus according to claim 4,
wherein the navigation unit informs that the at least one landmark extracted by the extracting unit cannot be recognized if the determination unit determines that the characteristic object cannot be recognized.
